(19) United States
(12) Patent Application Publication
(10) Pub. No.: US 2018/0265990 A1
(43) Pub. Date: Sep. 20, 2018

(54) METAL LAMINATE MATERIAL AND METHOD FOR PRODUCING THE SAME

(71) Applicant: Toyo Kohan Co., Ltd., Tokyo (JP)

(72) Inventors: Kouji Nanbu, Kudamatsu-shi, Yamaguchi (JP); Yusuke Hashimoto, Kudamatsu-shi, Yamaguchi (JP); Hironao Okayama, Kudamatsu-shi, Yamaguchi (JP)

(73) Assignee: Toyo Kohan Co., Ltd., Tokyo (JP)

(21) Appl. No.: 15/764,398

(22) PCT Filed: Sep. 30, 2016
(86) PCT No.: PCT/JP2016/079071

§ 371 Date: Mar. 29, 2018

(30) Foreign Application Priority Data
Sep. 30, 2015 (JP) 2015-192915

(51) Int. Cl. C23F 4/00; B32B 15/01; B23K 20/04; C21D 9/00; C22F 1/06; B32B 37/18

(52) U.S. Cl. CPC C23F 4/00; B32B 15/013; B23K 20/04; B23K 2203/05; C22F 1/06; B32B 37/18; C21D 9/0068

(57) ABSTRACT

This invention provides a magnesium laminate material with high heat radiation performance, reduced weight, higher strength, and excellent molding processability. Such metal laminate material has a three-layer-structure of a first stainless steel layer, a magnesium layer and a second stainless steel layer, wherein tensile strength (TS) is 200 to 430 MPa, elongation (EL) is 10% or more, and the surface hardness (Hv) of the first stainless steel layer and the second stainless steel layer is 300 or less.

### TECHNICAL FIELD

The present invention relates to a metal laminate material and a method for producing the same.

### BACKGROUND ART

Metal laminate materials (clad materials), which are prepared by bonding two or more different metals to one another, are high-functional metal materials having composite properties not achievable with a single material. Such metal laminate materials have been conventionally produced by steps such as cleaning of surfaces to be bonded and roll bonding, etc.

An example of a known metal laminate material is a metal laminate material composed of stainless steel and aluminum. This metal laminate material is characterized by both lightweight properties of aluminum and strength of stainless steel. Compared with each component alone, such a laminate has higher molding processability and higher heat radiation performance, and it is thus used more extensively. From the viewpoint of applications to molding members for heat radiation, such as electronic devices and, in particular, mobile electronic devices, further both lightweight and high strength of the metal laminate material are required while maintaining high heat radiation performance.

Under the above circumstances, the present inventors had paid attention to magnesium as a material constituting a metal laminate material. Magnesium is advantageous over aluminum in terms of heat radiation performance, lightweight properties, and high specific intensity. However, magnesium has poor corrosion resistance, a slip plane is small, and, accordingly, there is an orientation dependence. Because of extremely low biaxial processability, in the past, applications of metal laminate materials comprising magnesium were more limited than those of metal laminate materials comprising aluminum.

As an example of the metal laminate material using magnesium, Patent Literature 1 discloses a magnesium-based metal clad plate comprising a magnesium metal layer and an anti-corrosion metal layer provided on either or both surfaces of the magnesium metal layer. In the examples of Patent Literature 1, a two-layer (thickness: 0.9 mm) or a three-layer clad plate is produced by using pure Ti for industrial application as an anti-corrosion metal, heating a Mg plate in an argon gas atmosphere at 300° C. for 10 minutes and heating a Ti plate in an argon gas atmosphere at 750° C. for 10 minutes for annealing, washing the surfaces of the Mg plate and the Ti plate with acetone, rubbing the bonded surfaces with a metal brush for surface activation, superposing the activated surfaces on top of each other to prepare a laminated material, heating the laminated material in an argon gas atmosphere at 300° C. for 10 minutes, and rolling the resultant at a rolling reduction of as high as 30% using a rolling reduction roll (hot rolling). According to this method of production, a pure Ti plate is used for the outside of the laminate material. Since pure Ti has surface hardness (Hv) of approximately 100 and it is thus soft, the Ti plate is likely to be bonded to the Mg plate. When stainless steel is used instead of the Ti plate, however, the hardness of stainless steel is not lowered under the hot rolling conditions described above, and the Ti plate cannot be bonded to the Mg plate. In Patent Literature 1, also, molding processability of the laminate material is tested; however, a heating temperature is 75° C. to 250° C. in the test, and the improvement in molding processability at room temperature is not intended.

Also, Patent Literature 2 discloses a method of bonding a first member composed of steel and a second member composed of a magnesium alloy comprising: a step of insertion by providing an insert between the first member and the second member; and a step of heating the first member and the second member with the insert provided there between to a particular temperature at which the insert becomes molten, thereby forming an intermetallic compound (Fe₂Al₅) at the interface between the first member and the second member. In this method of bonding, it is necessary that the first member and the second member be heated to a temperature at which they are molten with the use of another insert. In addition, the resulting laminate material is very thick, and application of the laminate material is limited to a constituting member, disadvantageously.

In addition, Patent Literature 3 describes a metal alloy laminate material composed of a magnesium alloy plate and a steel plate, which is prepared by heating the laminate material with pressurization while a single-component thermosetting adhesive is allowed to be present in a site between the surface of the magnesium alloy plate and the surface of the steel membrane, to harden the single-component thermosetting adhesive. Because of the use of an adhesive in this example, heat radiation performance is deteriorated disadvantageously. When the laminate material thickness is small, a lowering in heat radiation performance is deduced to be more apparent.

### CITATION LIST

### Patent Literature

Patent Literature 1: JP 2006-88435 A
Patent Literature 2: JP Patent No. 5,323,927
Patent Literature 3: JP Patent No. 5,372,469

### SUMMARY OF INVENTION

### Technical Problem

As described above, a magnesium-based material is examined as a metal laminate material used for a molding member for heat radiation or other application. However, conventional magnesium-based laminate materials were problematic and further improvement was required. Accordingly, the present invention is intended to provide a laminate material comprising a magnesium alloy (hereafter, it is occasionally referred to as “magnesium”) that is advantageous in terms of high heat radiation performance, lightweight, high strength, and molding processability and a method for producing the same.

### Solution to Problem

The present inventors have conducted concentrated studies in order to dissolve the problems described above. As a result, they discovered that the problems could be dissolved by regulating the degrees of tensile strength, elongation, and the surface hardness of the metal laminate of the three-layer structure comprising the stainless steel and the magnesium within the particular range, regulating the crystal grain size of the stainless steel layer, reducing the surface hardness of stainless steel, and performing activation bonding via sputter-etching when producing the laminate material. This has led to the completion of the present invention. Specifically, the present invention is summarized as follows.

(1) A metal laminate material having a three-layer-structure of a first stainless steel layer, a magnesium layer and a second stainless steel layer,

wherein tensile strength (TS) is 200 to 430 MPa, elongation (EL) is 10% or more, and the surface hardness (Hv) of the first stainless steel layer and the second stainless steel layer is 300 or less.

(2) The metal laminate material according to (1), wherein the average crystal grain size of the first stainless steel layer and the second stainless steel layer is 1.5 μm to 10 μm, and the number of shear bands that cross a 10 μm line along the sample coordinate system ND is less than 5 in the cross-sectional observation image from the sample coordinate system TD.
(3) A method for producing the metal laminate material according to (1) or (2) comprising:

a step of subjecting the first stainless steel plate or foil having surface hardness (Hv) of 300 or less to sputter-etching;

a step of subjecting a magnesium plate or foil having surface hardness (Hv) of 50 or more to sputter-etching;

a step of subjecting the surface of the first stainless steel plate or foil to roll bonding to the surface of the magnesium plate or foil subjected to sputter-etching to obtain a bi-layer material of the first stainless steel layer/the magnesium layer;

a step of subjecting the surface of the magnesium layer of the bi-layer material to sputter-etching;

a step of subjecting the second stainless steel plate or foil having surface hardness (Hv) of 300 or less to sputter-etching; and

a step of subjecting the bi-layer material to roll bonding to the surface of the second stainless steel plate or the foil subjected to sputter-etching to obtain a metal laminate material of a three-layer-structure of the first stainless steel layer/the magnesium layer/the second stainless steel layer.

(4) The method for producing the metal laminate material according to (3), wherein the surfaces subjected to sputter-etching are subjected to roll bonding at a rolling reduction of 25% or less.
(5) A method for producing a metal laminate material comprising a step of subjecting the metal laminate material obtained by the method of production according to (3) or (4) to heat treatment at 100° C. to 590° C.

The present description includes the contents as disclosed in the description and/or drawings of Japanese Patent Application No. 2015-192915, which is a priority document of the present application.

### Advantageous Effects of the Invention

The present invention can provide a metal laminate material having a three-layer-structure of the first stainless steel layer/the magnesium layer/the second stainless steel layer, which is excellent in terms of high heat radiation performance, molding processability, lightweight, and high strength.

### BRIEF DESCRIPTION OF DRAWINGS

FIG. 1 schematically shows a cross-sectional view of the metal laminate material according to an embodiment of the present invention.

FIG. 2 shows a chart demonstrating the correlation between surface hardness and height of bulge of the metal laminate materials obtained in Examples 1 to 4.

FIG. 3 shows a chart demonstrating the correlation between tensile strength and height of bulge of the metal laminate materials obtained in Examples 1 to 4.

FIG. 4 shows a chart demonstrating the correlation between elongation and height of bulge of the metal laminate materials obtained in Examples 1 to 4.

FIG. 5 shows images of cross sectional planes observed under a scanning electron microscope (SEM) used to determine the average crystal grain size. FIG. 5A shows a stainless steel foil 1 alone, FIG. 5B shows the stainless steel layer of the metal laminate material (Example 3) after bonding (as a clad material), and FIG. 5C shows the stainless steel layer of the metal laminate material (Example 1) after bonding and heat treatment.

FIG. 6 shows images of cross sectional planes observed under a scanning electron microscope (SEM) used to determine the average crystal grain size. FIG. 6A shows a stainless steel foil 2 alone, and FIG. 6B shows the stainless steel layer of the metal laminate material (Example 2) after bonding and heat treatment.

FIG. 7 shows an image of the cross sectional plane of the stainless steel foil 1 alone used to evaluate shear bands observed under the scanning electron microscope (SEM).

FIG. 8 shows an image of the cross sectional plane of the stainless steel foil 3 alone used to evaluate shear bands observed under the scanning electron microscope (SEM).

### DESCRIPTION OF EMBODIMENTS

Hereafter, the present invention is described in detail.

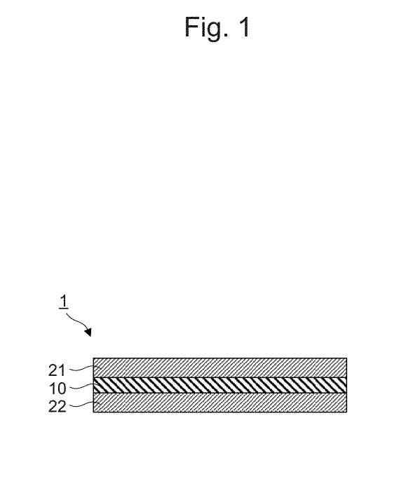

As shown in FIG. 1, the metal laminate material 1 of the present invention has the three-layer structure of the first stainless steel layer 21/the magnesium layer 10/the second stainless steel layer 22. Such a three-layer structure comprises the magnesium layer 10, the first stainless steel layer 21 bonded to a surface thereof, and the second stainless steel layer 22 bonded to the other surface of the magnesium layer 10. The stainless steel layers provided on both surfaces of the magnesium layer can cover low anti-corrosion properties of the magnesium layer sandwiched between the stainless steel layers.

The metal laminate material 1 of the present invention has tensile strength (TS) of 200 to 430 MPa and elongation (EL) of 10% or more, and the surface hardness (Hv) of the first stainless steel layer 21 and the second stainless steel layer 22 is 300 or less. The lower limit of TS is preferably 220 or more and the upper limit thereof is preferably 400 or less, more preferably 390 or less, and further preferably 365 or less. EL is preferably 12% or more, and more preferably 20% or more. Hv is preferably 280 or less, and further preferably 249 or less. Within the above range, molding processability of the metal laminate material 1 is sufficient. Specifically, high molding processability, such that the height of bulge determined by the Erichsen test is 3 mm or more, preferably 3.2 mm or more, and more preferably 3.5 mm or more, can be attained. It was impossible to produce a laminate material with hardness (Hv) of 300 or more or TS of 430 MPa or more, as described in the examples below. It is deduced that the stainless steel plate or foil with high hardness and tensile strength could not be bonded to the magnesium with low molding processability because a sufficient contact area could not be formed at the interface between the stainless steel plate or the foil and the magnesium. Even if bonding was sufficiently performed, Ts exceeding 430 MPa would result in improved strength; however, the Erichsen value would not reach 3 mm, and molding processability may not be sufficient. When hardness (Hv) is over 300, also, the whole molding processability is likely to be insufficient due to the causes of high hardness (i.e., solid-solution elements, deposits, and processing strain). In the present invention, tensile strength (TS) and elongation (EL) are measured in accordance with JIS Z2241 (the method of metallic material tensile testing), and surface hardness (Hv) is measured in accordance with JIS Z2244 (the Vickers hardness test, load: 100 gf). The height of bulge determined by the Erichsen test is measured in accordance with JIS Z2247 (the Erichsen test).

It is preferable for the metal laminate material 1 of the present invention that the average crystal grain size of the first stainless steel layer 21 and the second stainless steel layer 22 be 1.5 μm to 10 μm and the number of shear bands that cross a 10-μm line along the sample coordinate system ND (normal direction) in the image of the cross sectional plane from the sample coordinate system TD (transverse direction) be less than 5. Thus, high molding processability can be achieved. The average crystal grain size is more preferably 1.5 μm to 8.0 μm, and particularly preferably 2.0 μm to 6.0 μm. The number of shear bands that cross a 10-μm line is more preferably 3 or less, further preferably 1 or less, and particularly preferably 0.

The average crystal grain size is determined by arbitrarily selecting 30 crystal grains in the image of the cross-sectional plane observed under a scanning electron microscope (SEM) from the sample coordinate system TD of the metal laminate material, measuring the longer diameter and the shorter diameter of each crystal grain, determining the average of the longer diameter and the shorter diameter as a grain size of the crystal grain, and determining the average grain size of the 30 crystal grains. In the present invention, the number of crossing shear bands is determined by drawing ten 10-μm lines along the thickness direction (the sample coordinate system ND) of the metal laminate material in the image of the cross-sectional plane observed under SEM from the sample coordinate system TD of the metal laminate material, counting the number of shear bands crossing each line, and determining the average number of the 10 lines.

In the present invention, RD (rolling direction) corresponds to the direction of rolling, TD (transverse direction) corresponds to the direction perpendicular to RD, and ND (normal direction) corresponds to the direction normal to the rolling surface (plate surface).

Stainless steel materials constituting the first stainless steel layer 21 and the second stainless steel layer 22 are not particularly limited, and plates or foils of, for example, SUS304, SUS210, SUS316, SUS316L, and SUS430, can be used. In order to adjust Hv to 300 or lower after bonding, it is necessary that the surface hardness (Hv) of the plate or foil be 300 or less before bonding. As a result of roll bonding between the stainless steel layer and the magnesium plate or foil, processing strain is introduced into the stainless steel, and the surface hardness (Hv) is generally increased. However, it is preferable that a difference between hardness of the plate or foil before bonding and that after bonding (i.e., the state of the metal laminate material 1 as shown in FIG. 1) be 100 or less. A difference in hardness exceeding 100 is not preferable because processing strain of the stainless steel layer is excessively large, and molding processability is deteriorated. In general, it is sufficient that thickness of the stainless steel plate or foil be 0.01 mm or more. From the viewpoint of mechanical strength and processability of the resulting metal laminate material, the thickness is preferably 0.01 mm to 0.6 mm, and more preferably 0.01 mm to 0.3 mm, although the thickness is not limited thereto.

As a magnesium plate or foil, pure magnesium or magnesium alloy can be used without particular limitation. Specific examples include AZ31, AZ61, AZ91, and LZ91. When the surface hardness (Hv) of the magnesium plate or foil is excessively high, molding processability of the metal laminate material is deteriorated after bonding. When Hv is excessively low, in contrast, handling of the metal laminate material becomes difficult. Thus, surface hardness (Hv) should adequately be determined by taking such problems into consideration. While surface hardness (Hv) is preferably 50 to 100, it is not limited thereto. In addition, the magnesium plate or foil with thickness of 0.01 mm or more is generally sufficient. From the viewpoint of mechanical strength and processability of the resulting metal laminate material, thickness is preferably 0.01 mm to 1 mm, although the thickness is not limited thereto.

When producing the metal laminate material 1, at the outset, a bi-layer material of the first stainless steel layer/the magnesium layer is obtained by a process comprising a step of subjecting the first stainless steel plate or foil (hereafter, it is referred to as “plate etc.”) to sputter-etching and a step of subjecting the magnesium plate or foil to sputter-etching, followed by roll bonding of the surface of the first stainless steel plate or foil to the surface of the magnesium plate or foil. Subsequently, the metal laminate material 1 having a three-layer structure of the first stainless steel layer 21/the magnesium layer 10/the second stainless steel layer 22 as shown in FIG. 1 can be produced by a process comprising a step of subjecting the surface of the magnesium layer of the bi-layer material to sputter-etching and a step of subjecting the second stainless steel plate or foil to sputter-etching, followed by roll bonding of the surface of the second stainless steel plate or foil to the bi-layer material.

Sputter-etching can be carried out by preparing, for example, the first stainless steel plate etc. and the magnesium plate etc. (the same applies to the case in which a bi-layer material and the second stainless steel plate are subjected to sputter-etching) as a long coil with a width of 100 mm to 600 mm, designating stainless steel connected to magnesium as a ground-connected electrode, applying an alternating current of 1 MHz to 50 MHz to a region between the electrode and the other insulated electrode to generate glow discharge, and adjusting an area of the electrode exposed to the plasma generated by the glow discharge to one third or less of the area of the other electrode. During sputter-etching, the ground-connected electrode is in the form of a cooling roll, which prevents the transfer materials from temperature raising.

Sputter-etching treatment is intended to completely remove substances adsorbed to the surface and remove a part of or the entire oxide film on the surface by subjecting a surface on which stainless steel is bonded to magnesium to sputtering with inert gas in vacuum. It is not necessary to completely remove the oxide film, and stainless steel can be sufficiently bonded to magnesium in the presence of a remaining part of the oxide film. In the presence of a part of the oxide film remained, the duration of the sputter-etching treatment is shortened to a significant extent, and productivity of metal laminate materials is improved, compared to the case in which the oxide film is completely removed. Examples of inert gas that can be applied include argon, neon, xenon, krypton, and a mixed gas comprising at least one of the inert gases mentioned above. Substances adsorbed to the surface of stainless steel and magnesium can be completely removed with the etching amount of about 1 nm.

Stainless steel can be subjected to sputter-etching in vacuum at, for example, plasma output of 100 W to 10 kW and a line velocity of 0.5 m/min to 30 m/min. While a higher degree of vacuum is preferable in order to prevent substances from being adsorbed to the surface again, a degree of vacuum of, for example, 1×10⁻⁵ Pa to 10 Pa is sufficient. In sputter-etching, the temperature of stainless steel is preferably maintained at room temperature to 150° C. so as to prevent magnesium from softening.

In the present invention, stainless steel comprising an oxide film remaining in a part on its surface can be obtained by adjusting the amount of stainless steel etching to, for example, 1 nm to 10 nm. According to need, the amount of etching may exceed 10 nm.

Magnesium can be subjected to sputter-etching in vacuum at, for example, plasma output of 100 W to 10 kW and a line velocity of 0.5 m/min to 30 m/min. While a higher degree of vacuum is preferable in order to prevent substances from being adsorbed to the surface again, a degree of vacuum of 1×10⁻⁵ Pa to 10 Pa is sufficient.

In the present invention, magnesium comprising an oxide film remaining in a part on its surface can be obtained by adjusting the amount of magnesium etching to 1 nm to 10 nm. According to need, the amount of etching may exceed 10 nm.

A first stainless steel plate etc. can be subjected to roll bonding to a magnesium plate etc. and a bi-layer material can be subjected to roll bonding to a second stainless steel plate etc. A line pressure load for roll bonding is not particularly limited. For example, it can be adjusted to 0.1 to 10 tf/cm. At the time of roll bonding, the temperature is not particularly limited, and it is, for example, room temperature to 150° C.

If a rolling reduction exceeds 25% at the time of roll bonding, a large amount of processing strain is introduced, and the resulting metal laminate material is likely to suffer from poor molding processability. Accordingly, a rolling reduction is preferably 15% or less, and more preferably 10% or less. It is not necessary that the thickness before roll bonding be different from that after roll bonding. Thus, the lower limit of the rolling reduction is 0%.

Rolling bonding is preferably carried out in a nonoxidative atmosphere, such as an inert gas atmosphere of Ar, so as to avoid a lowered bonding force between stainless steel and magnesium caused by readsorption of oxygen to the surface of stainless steel and magnesium.

The average crystal grain size of the stainless steel plate or foil before bonding measured in the same manner as in the case of the metal laminate material is preferably 1.5 μm to 10 μm, and the number of shear bands crossing a 10-μm-long line along the sample coordinate system ND is preferably less than 5. With the use of such stainless steel plate or foil while regulating a rolling reduction within the range described above, the metal laminate material of the three-layer structure, which has tensile strength (TS) of 200 to 430 MPa, elongation (EL) of 10% or more, and surface hardness (Hv) of the stainless steel layer of 300 or less, can be obtained with certainty. When the number of shear bands crossing the line is large or a rolling reduction is high before bonding, the number of shear bands crossing the line remains large after lamination, and molding processability may be lowered, disadvantageously.

It is preferable that the metal laminate material of the three-layer structure obtained via roll bonding be further subjected to heat treatment, according to need. Through heat treatment, processing strain of the magnesium layer is removed, and adhesion between layers can be improved. It is necessary that the heat treatment be carried out at a temperature lower than the magnesium melting point. For example, the melting point of the magnesium alloy AZ31 is approximately 600° C. Accordingly, heat treatment is carried out at 590° C. or lower, and preferably at 500° C. or lower, so as to prevent magnesium from being molten. The lower limit for heat treatment temperature is preferably 100° C., and more preferably 150° C.

Further, the heat treatment is preferably carried out at a temperature at which metal elements of stainless steel thermally diffuse to magnesium. A bonding force is improved by thermal diffusion.

Specifically, heat treatment can be carried out at 100° C. to 590° C. When heat treatment is carried out within such temperature ranges, the metal laminate material resulting from thermal diffusion has a high bonding force and high hardness of the reinforcing material, and magnesium can be prevented from being molten when heated. Heat treatment is preferably carried out at 150° C. to 500° C., so as to further enhance the bonding force and prevent magnesium from being molten. While the duration of heat treatment varies depending on temperature, a duration of 1 second to approximately 240 minutes is sufficient at, for example 300° C. (the duration does not include the temperature-rising time).

The thickness of the metal laminate material of the three-layer structure produced by the procedure described above is not particularly limited. The present invention can provide a thin metal laminate material with high molding processability by regulating tensile strength, elongation, and surface hardness of the stainless steel layer within given ranges. Specifically, the thickness of the metal laminate material can be, for example, 50 μm to 800 μm, preferably less than 700 μm, and further preferably less than 600 μm. As the proportion of the stainless steel layer accounting for the metal laminate material of the three-layer structure increases, molding processability is likely to be high. From the viewpoint of weight reduction, however, it is preferable that the proportion of magnesium be greater. When the thickness of the magnesium layer is excessively large compared with the thickness of the stainless steel layer, disadvantageously, molding processability of the metal laminate material is deteriorated.

### EXAMPLES

Hereafter, the present invention is described in greater detail with reference to the examples and the comparative examples provided below, although the scope of the present invention is not limited to these examples.

### Examples 1 to 4 and Comparative Example 1

SUS316 and SUS316L were used as the first stainless steel foil and the second stainless steel foil, and ZA31 was used as a magnesium foil. Table 1 shows characteristic values of the test materials. The hardness was tested using a Micro Vickers Hardness Tester (load: 100 gf), tensile strength and elongation were tested using a tensile tester (Autograph AGS-5kNS, Shimadzu Corporation), and height of bulge was tested using a mechanical Erichsen tester ESM-1 (CAP: 2 mm, Tokyo Koki Testing Machine Co., Ltd.).

TABLE 1

| | | | | | | | Height |
|---|---|---|---|---|---|---|---|
| | Test | | Thickness | Hardness | TS | Elongation | of bulge |
| | material | Refining | (mm) | Hv | (Mpa) | (%) | (mm) |
| Stainless steel foil 1 | SUS316 | BA | 0.0494 | 200.82 | 503 | — | 8.09 |
| Stainless steel foil 2 | SUS316L | ½H | 0.0502 | 257.76 | 704 | 45.5 | 5.98 |
| Stainless steel foil 3 | SUS316L | H | 0.0496 | 372.4 | 1095 | 3.6 | 2.98 |
| Magnesium foil 1 | AZ31 | | 0.495 | 77.28 | 319.3 | 15.0 | 2.42 |
| Magnesium foil 2 | AZ31 | | 0.598 | 69.66 | 275.1 | 16.7 | 2.12 |

Subsequently, the first stainless steel foil and the magnesium foil were subjected to sputter-etching. The first stainless steel foil was subjected to sputter-etching at 0.1 Pa and plasma output of 700 W for 20 minutes. The magnesium foil was subjected to sputter-etching at 0.1 Pa and plasma output of 700 W for 20 minutes. Thus, substances adsorbed to the surfaces of the first stainless steel foil and the magnesium foil were completely removed. After the sputter-etching treatment, the first stainless steel foil was subjected to roll bonding to the magnesium foil at room temperature at a line pressure load of 2 tf/cm. Thus, a bi-layer material was obtained.

Subsequently, the surface of the magnesium layer and the second stainless steel foil of the bi-layer material were subjected to sputter-etching. The bi-layer material was subjected to sputter-etching at 0.1 Pa and plasma output of 700 W for 20 minutes, the second stainless steel foil was subjected to sputter-etching at 0.1 Pa and plasma output of 700 W for 20 minutes, and substances adsorbed to the surfaces of the magnesium layer and the second stainless steel foil were completely removed. The magnesium layer and the second stainless steel foil of the bi-layer material were subjected to roll bonding to each other via at room temperature and a line pressure load of 2 tf/cm. Thus, a metal laminate material having a three-layer-structure of the first stainless steel layer/the magnesium layer/the second stainless steel layer was produced. The metal laminate materials (as clad materials) correspond to Examples 3 and 4. The reduction of the laminate material obtained in the end was determined in accordance with the formula (1) shown below, the rolling reduction of Example 3 was 8%, and that of Example 4 was 6.3%.

(Total thickness of test materials−thickness of laminate material)/(total thickness of test materials)×100(%) Formula (1)

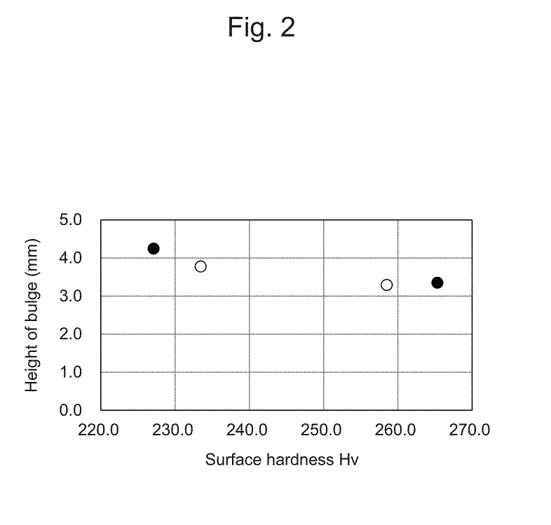

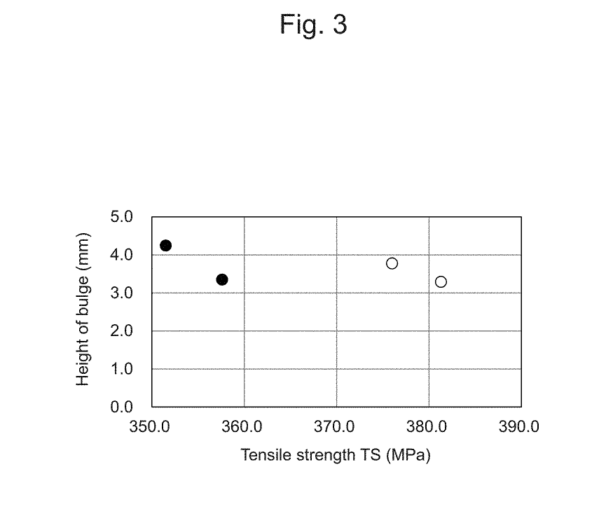

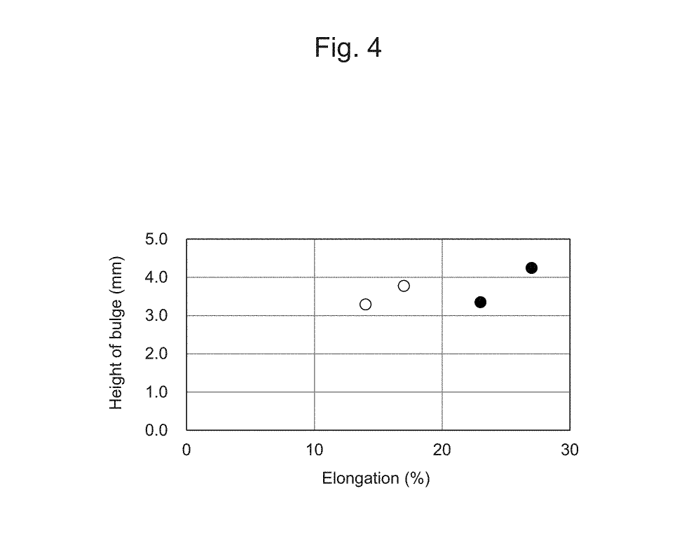

The metal laminate materials obtained through the procedure described above were further subjected to heat treatment at 300° C. for 30 minutes. The metal laminate materials subjected to the heat treatment correspond to Examples 1 and 2. Table 2 summarizes characteristic values of the metal laminate materials produced. FIGS. 2 to 4 show the correlation between surface hardness (Hv), tensile strength (TS), and elongation of the metal laminate material and the height of bulge determined by the Erichsen test, respectively. Surface hardness of the stainless steel layer and that of the magnesium layer were measured at a load of 100 gf.

TABLE 2

| | | | | | | Height |
|---|---|---|---|---|---|---|
| | | Thickness | Hardness | TS | Elongation | of bulge |
| No. | Constitution | (mm) | Hv | (MPa) | (%) | (mm) |
| Ex. 1 | Stainless steel foil 1/Magnesium foil 1/ | 0.541 | 227.1 | 351.5 | 27 | 4.2 |
| | Stainless steel foil 1 | | | | | |
| Ex. 2 | Stainless steel foil 2/Magnesium foil 1/ | 0.558 | 265.3 | 357.6 | 23 | 3.4 |
| | Stainless steel foil 2 | | | | | |
| Ex. 3 | Stainless steel foil 1/Magnesium foil 1/ | 0.541 | 233.44 | 376.0 | 17 | 3.8 |
| | Stainless steel foil 1 | | | | | |
| Ex. 4 | Stainless steel foil 2/Magnesium foil 1/ | 0.558 | 258.5 | 381.3 | 14 | 3.3 |
| | Stainless steel foil 2 | | | | | |

| | | |
|---|---|---|
| Comp. Ex. 1 | Stainless steel foil 3/Magnesium foil 1/ | Impossible to bond |
| | Stainless steel foil 3 | |

Ex. 1 and Ex. 2: after heat treatment (300° C. × 30 min);
Ex. 3 and Ex. 4: as clads

When tensile strength (TS) was 200 to 430 MPa, elongation (EL) was 10% or more, and surface hardness (Hv) was 300 or less (Examples 1 to 4), as shown in Table 2, the height of bulge was found to be 3 mm or more and high molding processability was achieved. When test materials SUS316U (H materials) having surface hardness (Hv) exceeding 300 were used as the first and the second stainless steel foils (Comparative Example 1), it was not possible to bond the stainless steel foils to the magnesium foil. While the reason why the stainless steel foils were not bonded to the magnesium foil is not apparent, it is assumed that bonding cannot take place because of lack of a sufficient area of contact at the interface of the surfaces to be bonded when the stainless steel foils with high hardness are to be bonded to magnesium with poor molding processability.

The results of comparison of Example 3 and Example 1 and comparison of Example 4 and Example 2 also demonstrate that the height of bulge would be improved via heat treatment and more sufficient molding processability would be achieved.

### (Evaluation of Average Crystal Grain Size)

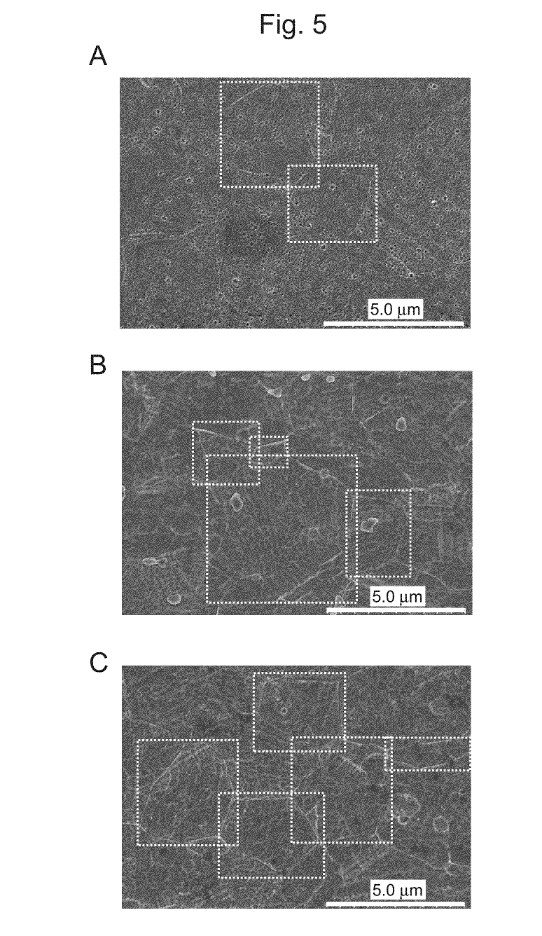

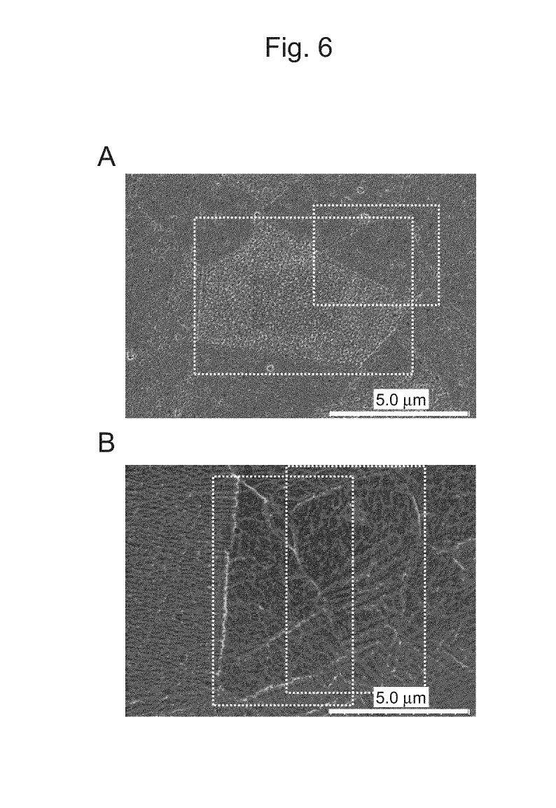

The average crystal grain sizes of the stainless steel layers of the metal laminate materials of Examples 1 to 3 were determined in the manner described below. At the outset, samples of the metal laminate materials were soaked in aqua regia diluted to about one third as corrosive liquids for about 10 to 15 minutes, and the stainless steel layers were subjected to etching. Thereafter, the stainless steel layers of the samples subjected to etching were observed at the cross sectional plane from the sample coordinate system TD using an SEM (the field-emission scanning electron microscope SU8020, Hitachi High Technologies). On the basis of the observation images, the average crystal grain size was determined in accordance with the definition above. For comparison, the average crystal grain size of the stainless steel foil 1 and that of the stainless steel foil 2 before bonding were measured. The results of measurement are shown in Table 3. FIG. 5A to FIG. 5C each show the SEM observation image of the stainless steel foil 1 alone, after bonding of the stainless steel foil 1 (as a clad material, corresponding to Example 3), and after bonding of the stainless steel foil 1, followed by heat treatment (corresponding to Example 1). FIG. 6A and FIG. 6B each show the SEM observation image of the stainless steel foil 2 alone and after bonding of the stainless steel foil 2, followed by heat treatment (corresponding to Example 2). In the figures, regions surrounded by frames represent crystal grains.

TABLE 3

| Test material alone | | After bonding (as clads) | | After heat treatment | |
|---|---|---|---|---|---|
| Stainless steel foil 1 | 2.6 | Ex. 3 | 2.9 | Ex. 1 | 2.9 |
| (SUS316, BA) | | | | | |

| | | | | |
|---|---|---|---|---|
| Stainless steel foil 2 | 5.5 | — | Ex. 2 | 6.5 |
| (SUS316L, ½ H) | | | | |

Unit: μm

As shown in Table 3, the average crystal grain size of the stainless steel layers of the metal laminate materials of Examples 1 to 3 with sufficient molding processability was within the range of 1.5 μm to 10 μm. Concerning the stainless steel foil 3 (SUS316L, H material), it was difficult to determine the crystal grain size due to the presence of shear bands.

### (Evaluation of Shear Band)

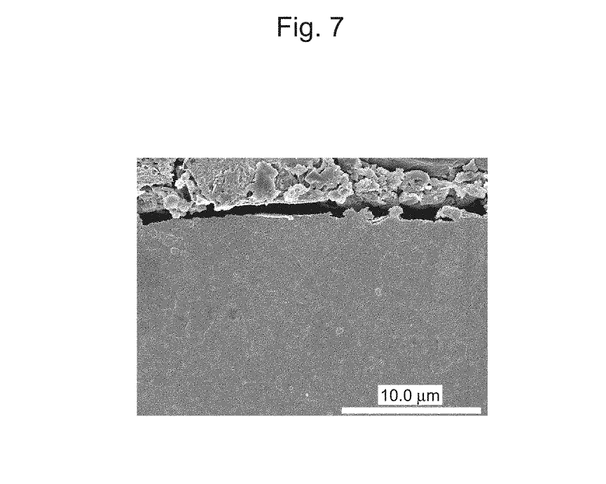

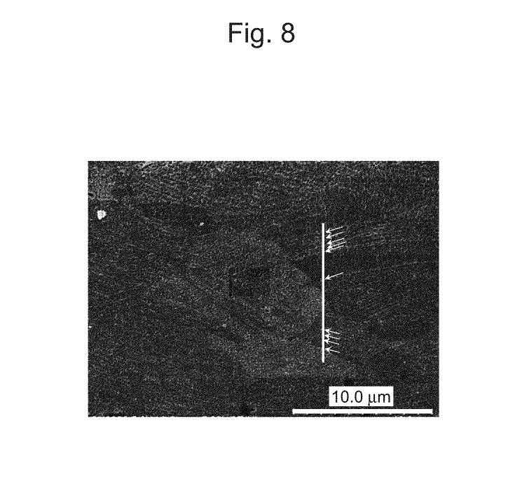

Regarding the metal laminate materials of Examples 1 to 3, subsequently, the number of shear bands crossing a 10-μm line along the sample coordinate system ND in the cross-sectional observation image from the sample coordinate system TD was determined in accordance with the definition above. The apparatuses used to evaluate the average crystal grain size above were used for measurement. For comparison, the number of shear bands of the stainless steel foil 1 and that of the stainless steel foil 3 before bonding were measured. The results of measurement are shown in Table 4. FIG. 7 and FIG. 8 each show the SEM observation image of the stainless steel foil 1 alone and the stainless steel foil 3 alone. In FIG. 8, an arrow points a site at which a shear band crosses the line.

TABLE 4

| Test material alone | | After bonding (as clads) | | After heat treatment | |
|---|---|---|---|---|---|
| Stainless steel foil 1 | 0 | Ex. 3 | 0 | Ex. 1 | 0 |
| SUS316 (BA) | | | | | |
| Stainless steel foil 3 | 6 | Comp. Ex. 1 | Impossible | — | — |
| SUS316L (H) | | | to bond | | |

Numerical values in the tables indicate the numbers of shear bands crossing the line

As shown in Table 4, no shear bands crossing the line were observed in the stainless steel layer of Example 3. In addition, no shear bands were observed in the stainless steel foil 1 before bonding (FIG. 7). On the basis of the results of observation, it is deduced that a metal laminate material would achieve high molding processability with the use of a stainless steel layer without shear bands. In contrast, as many as 6 shear bands were observed in the unbondable stainless steel foil 3.

### DESCRIPTION OF NUMERAL REFERENCES

1: Metal laminate material
10: Magnesium layer
21: First stainless steel layer
22: Second stainless steel layer

All publications, patents, and patent applications cited herein are incorporated herein by reference in their entirety.

We claim:

1. A metal laminate material having a three-layer-structure of a first stainless steel layer, a magnesium layer and a second stainless steel layer,
wherein tensile strength (TS) is 200 to 430 MPa, elongation (EL) is 10% or more, and the surface hardness (Hv) of the first stainless steel layer and the second stainless steel layer is 300 or less.

2. The metal laminate material according to claim 1, wherein the average crystal grain size of the first stainless steel layer and the second stainless steel layer is 1.5 μm to 10 μm, and the number of shear bands that cross a 10 μm line along the sample coordinate system ND is less than 5 in the cross-sectional observation image from the sample coordinate system TD.

3. A method for producing the metal laminate material according to claim 1 comprising:
a step of subjecting the first stainless steel plate or foil having surface hardness (Hv) of 300 or less to sputter-etching;
a step of subjecting a magnesium plate or foil having surface hardness (Hv) of 50 or more to sputter-etching;
a step of subjecting the surface of the first stainless steel plate or the foil to roll bonding to the surface of the magnesium plate or foil subjected to sputter-etching to obtain a bi-layer material of the first stainless steel layer/the magnesium layer;
a step of subjecting the surface of the magnesium layer of the bi-layer material to sputter-etching;
a step of subjecting the second stainless steel plate or foil having surface hardness (Hv) of 300 or less to sputter-etching; and
a step of subjecting bi-layer material to roll bonding to the surface of the second stainless steel plate or the foil subjected to sputter-etching to obtain a metal laminate material of a three-layer-structure of the first stainless steel layer/the magnesium layer/the second stainless steel layer.

4. The method for producing the metal laminate material according to claim 3, wherein the surfaces subjected to sputter-etching are subjected to roll bonding at a rolling reduction of 25% or less.

5. A method for producing a metal laminate material comprising a step of subjecting the metal laminate material obtained by the method of production according to claim 3 to heat treatment at 100° C. to 590° C.
